(19) United States
(12) Patent Application Publication
(10) Pub. No.: US 2008/0264375 A1
(43) Pub. Date: Oct. 30, 2008

(54) Dual connecting rod piston

(76) Inventor: Ted Hollinger, Algona, IA (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 11/796,080

(22) Filed: Apr. 26, 2007

(51) Int. Cl. F02F 3/00

(52) U.S. Cl. 123/193.6

(57) ABSTRACT

A piston and connecting rod is provided. The piston comprises a piston and a plurality of connecting rods. A very large displacement engine is built using one piston with the plurality of connecting rods, wherein the one piston has the combined diameter of two pistons in a smaller bore engine. The connecting rods are spaced to operatively connect with a standard crankshaft style, where each connecting rod of the two smaller, standard pistons would connect to the crankshaft.

### BACKGROUND OF THE INVENTION

1. Field

The present invention relates to a dual connecting rod piston. In particular, to a dual connecting rod piston in which the piston is a large bore piston and the piston mechanically connects to two connecting rods. The use of the dual connecting rod piston in an internal combustion engine results in a very large displacement engine.

2. Background

Internal combustion engines are well known in the art. Engines of this type predominate the current market due to the fact that they are relatively efficient, inexpensive, and easy to fuel. Generally speaking, the internal combustion engine utilizes an exothermic reaction of a fuel and gas in a combustion chamber to drive one or more pistons. The pistons are in mechanical communication with a drive shaft via connecting rods such that the reciprocating motion of the pistons is translated into rotational movement of the driveshaft. In this manner, the engine can produce power that can then be harnessed for a variety of purposes, such as movement, electrical generation, and the like.

The most common combustion mixture utilized for internal combustion engines is gasoline and air. Accordingly, modern internal combustion engines are optimized to maximize the efficiency of this type of operation. One of the results of these efficiencies is that conventional piston bore sizes of a gasoline engine typically range between three to four inches in diameter, but never larger than five inches. Due to the flame velocity of gasoline, gasoline cannot burn fast enough to be used effectively much above four inch bore sizes (four inch pistons). Larger bore sizes in gasoline powered internal combustion engines are not practical because the additional fuel required to take advantage of the larger bore could not burn in the time available. Furthermore, as gasoline has a very high btu rating, it can produce sufficient power within the conventional range of piston size for satisfactory operation. Thus, these conditions reduce the usefulness of larger bore piston sizes. These dynamics, however, create limitations that make it impractical to efficiently use many alternative fuels in conventional internal combustion engines.

In particular, fuels with a lower btu rating, such as hydrogen, cannot generate enough power within the conventional piston size range to produce optimal results.

A further constraint on the efficient use of alternative fuels in internal combustion engines is the need to reduce emissions. A primary path for emission reduction in internal combustion engines is through the introduction of additional oxygen to the fuel mixture to force the engines to run leaner. For example, hydrogen-fueled engines require running at about a 0.4 Equivalence Ratio (EQR) to a achieve <10 ppm NOₓ emissions. To run at an EQR of 0.4, as opposed to stoichiometric, two and a half times more air is required. Running a low btu fuel under these conditions with conventional internal combustion engines bore sizes would further greatly reduce power output. It would not be possible to increase engine efficiency sufficiently to regain the resulting power loss without making radical and expensive changes in engine design.

For example, one way to overcome the lower power output is to add a turbocharger or supercharger to force more air into the cylinder. This method can achieve approximately a doubling of the output power, but it also adds considerable cost and complexity to the system.

Thus, the need exists for a means to adapt internal combustion engines to efficiently and cost-effectively utilize alternative fuels, such as low btu fuels like hydrogen, with minimal modification to existing engine design.

### SUMMARY OF THE INVENTION

An object of this invention is to provide an apparatus for increasing the power output of low btu fueled internal combustion engines.

These and other objects of the present invention will become apparent to those skilled in the art upon reference to the following specification, drawings, and claims.

The present invention intends to overcome the difficulties encountered heretofore. To that end, a dual connecting rod piston is provided. The invention comprises a piston with two connecting rods, wherein the connecting rods are in mechanical communication with the crankshaft. The piston is a large bore piston that takes the place of two smaller pistons in a smaller bore engine. Use of the piston and dual connecting rods in an internal combustion engine results in an engine with a very large displacement.

### BRIEF DESCRIPTION OF THE DRAWINGS

FIG. 1 is a top view of the piston with two connecting rods of the present invention.

FIG. 2 is a bottom view of the piston with two connecting rods of the present invention.

### DETAILED DESCRIPTION OF THE INVENTION

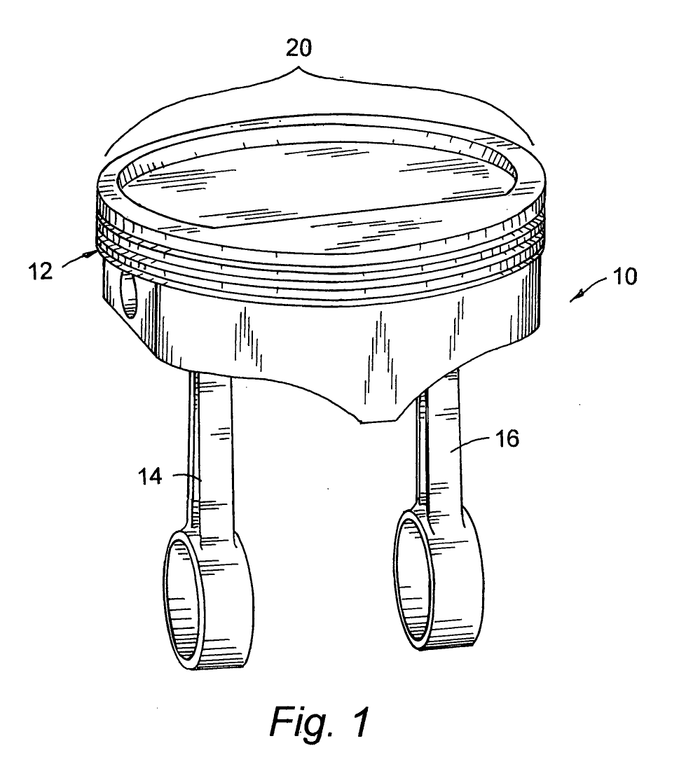

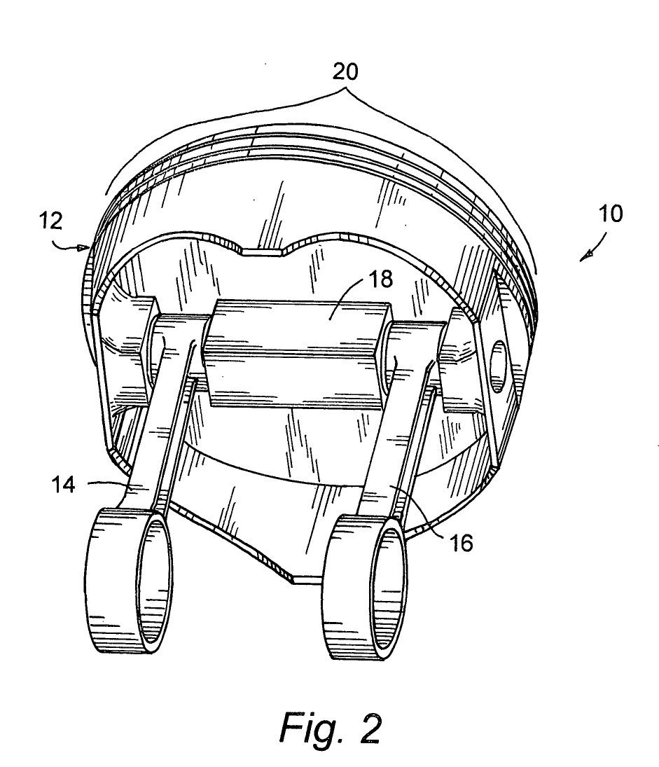

In the Figures, FIGS. 1-2 show a piston 10 of the current invention. The piston includes duel connecting rods 14, 16. The present invention substantially overcomes the limitations of the prior art and allowing for increased power output of an internal combustion engine, preferably engines that utilize low btu fuels such as hydrogen, by providing an increased piston size and utilizing two connecting rods 14, 16 to increase displacement. Furthermore, piston 10 and the dual connecting rods 14, 16 effectively increase engine displacement while maintaining the form, fit, and function of that engine. The piston 10 can be used to construct a very large displacement engine with the combined bore diameter of two standard pistons.

The piston 10 includes a wide diameter piston head 12, which is substantially larger than a piston that would be practical to use in a standard gasoline internal combustion engine. The bore size 20 of the piston head 12 is generally the diameter of the combination of the bore size of two smaller conventional sized pistons plus the spacing between them. The piston 12 is used in an engine used for conventional bore pistons. In general, two smaller standard pistons are replaced with the large bore piston 10 of the present invention.

As seen in FIG. 2, the connecting rods 14, 16 are attached to the piston pin 18 of the piston 12. The connecting rods 14, 16 are spaced along the piston pin 18 such that each rod 14, 16 attaches to the crankshaft in the same position as each single connecting rod of the two standard smaller bore pistons.

By using two connecting rods 14, 16 to connect one larger bore head 12 exactly where two individual connecting rods connect two standard pistons to the crankshaft, a standard crankshaft design can be employed. The only deviation from the basic engine structure that is required is to the crank pins or throws. The throws for the connecting rods must be positioned and fired in pairs. This style of crankshaft can be used on six-cylinder engines if the firing order is 1-3-5-2-4-6 or the equivalent.

In general, larger displacement engines are more powerful than smaller displacement engines, and thus better suited for he use of low btu alternative fuels such as hydrogen. In an internal combustion engine, displacement is calculated by multiplying the number of cylinders in the engine by the area of a piston and the length of the stroke. Displacement can be calculated from the bore diameter and stroke according to the following formula:

Displacement=(pi/4)(bore²)(stroke)(number of cylinders)

As demonstrated by this formula, increasing the bore size increases the displacement, or power, of the engine, by a power of 2. If six 4-inch pistons are replaced in an engine with three 8.5 inch dual connecting rod pistons 10 of the present invention, the displacement of each piston increases 4.5 times and the overall displacement of the engine increases by 2.25 times. Specifically, displacement increases from 300 cubic inches (4.9 liters) to 675 cubic inches (11 liters), while maintaining the same overall engine block. Accordingly, the piston 10 has a large diameter, or bore, relative to the engine block thereby providing the advantages disclosed herein.

In one embodiment of the invention, the piston 10 is used in a low btu fuel engine, such as hydrogen. Gasoline cannot burn fast enough to be used effectively at bore sizes much above four inches. As hydrogen burns about 8.3 times faster than gasoline, the piston size of a hydrogen fueled internal combustion engine could theoretically be increased by 8.3 times over the same gasoline fueled engine while still maintaining the same over all engine dynamics.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

1. A piston and connecting rod for connection to a multiple throw crankshaft of an internal combustion engine, comprising a piston and a plurality of connecting rods, a first end of each connecting rod operatively connected to the piston and a second end of each connecting rod operatively connected to a different throw of the crankshaft.

2. The piston and connecting rod of claim 1, wherein the piston has a piston pin.

3. The piston and connecting rod of claim 2, wherein the connecting rods operatively connect to the piston pin.

4. (canceled)

5. The piston and connecting rod of claim 3, wherein the connecting rods are spaced apart on the piston pin such that each connecting rod is adapted to be in mechanical communication with side-by-side crankshaft throws.

6. The piston and connecting rod of claim 1, wherein the piston is substantially larger than a gasoline engine piston.

7. (canceled)

8. The piston and connecting rod of claim 1 wherein said plurality of connecting rods is two.

9. (canceled)

10. (canceled)
